(19) United States
(12) Patent Application Publication
(10) Pub. No.: US 2010/0208298 A1
(43) Pub. Date: Aug. 19, 2010

(54) IMAGE FORMING APPARATUS

(75) Inventor: Kei Kitagata, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/704,108

(22) Filed: Feb. 11, 2010

(30) Foreign Application Priority Data
Feb. 17, 2009 (JP) 2009-034519

(51) Int. Cl. G06F 15/00

(52) U.S. Cl. 358/1.15

(57) ABSTRACT

An apparatus includes a receiving unit configured to receive an instruction from a client terminal, an acquisition unit configured to acquire print data from a server based on information about print data included in the instruction received by the receiving unit, a print unit configured to perform printing of the acquired print data, and a first transmission unit configured to create, if an error has occurred when the print unit performs printing, substitute printing information indicating an image forming apparatus to be a candidate for substituting printing, based on identification information for identifying the apparatus, which is included in the received instruction, and to transmit the substitute printing information to the client terminal.

### BACKGROUND OF THE INVENTION

1. Field of the Invention

The present invention relates to an image forming apparatus that performs printing of print data.

2. Description of the Related Art

Recently, an improvement in the network environment, such as a decrease in communication cost by spread of broadband, has led to realization of pull-printing. In pull-printing, print data acquired via the Internet is printed.

For example, when a user instructs pull-printing, the user may use a thin client terminal, which only includes a web browser. There are many benefits in using thin client terminals, such as reduced management cost of software to be distributed to client terminals, and prevention of information leak by not storing the data in the client terminal. As a result, a wide-spread use of the thin-client terminal is expected.

Further, in recent years, there is a technique in which a printer acquires a print job stored in a world-wide web (WWW) server and performs pull-printing (e.g., Japanese Patent Application Laid-Open No. 11-134125). In such a technique, the user selects a job stored in the WWW server via the web browser and performs printing.

Furthermore, there is a technique in which a print server acquires the print data from the WWW server via the Internet, generates data to be used in printing from the print data, and prints based on the data to be used in printing (e.g., Japanese Patent Application Laid-Open NO. 2000-194531). If a printer cannot print due to an error such as a paper or toner run out, or a paper jam, the printer server transfers the data to be used in printing to another printer connected to the Internet and prints the data. The print server compresses the data to be used in printing before transferring to another printer to reduce the load on the network.

In realizing such a print service (prints via the Internet) by a printer system, in terms of security, the print job from the print service and then print the print job is to be acquired.

However, in the technique discussed in Japanese Patent Application Laid-Open No. 11-134125, substitute printing cannot be performed by another printer when a printing error has occurred in the printer. Further, in the technique discussed in Japanese Patent Application Laid-Open NO. 2000-194531, if a printing error has occurred in the printer performing pull-printing by instruction from the client terminal, the print server is involved to determine whether to perform substitute printing.

### SUMMARY OF THE INVENTION

According to an aspect of the present invention, an apparatus includes a receiving unit configured to receive an instruction from a client terminal, an acquisition unit configured to acquire print data from a server based on information about print data included in the received instruction, a print unit configured to perform printing of the acquired print data, and a first transmission unit configured to create, if an error has occurred when the print unit performs printing, substitute printing information indicating an image forming apparatus to be a candidate for substituting printing, based on identification information for identifying the apparatus, which is included in the received instruction, and to transmit the substitute printing information to the client terminal.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a pull-printing system.

FIG. 2 is a block diagram illustrating a hardware configuration of an information processing apparatus.

FIG. 3 is a block diagram illustrating a hardware configuration of an image forming apparatus.

FIG. 4 is a block diagram illustrating an example of a functional configuration of each apparatus included in a pull-printing system.

FIG. 5 is a block diagram illustrating a configuration of a storing job management service.

FIG. 6 is a block diagram illustrating a configuration of a web server.

FIG. 7 illustrates a configuration of an image forming apparatus.

FIG. 8 is a block diagram illustrating a configuration of a pull-printing application.

FIG. 9 illustrates data and flow of each data in a pull-printing system.

FIG. 10 illustrates an example of configurations of a storing job information table and records.

FIG. 11 illustrates a configuration of storing job data.

FIG. 12 illustrates a configuration of a printer information table.

FIG. 13 illustrates a data structure of print job information.

FIG. 14 illustrates a data structure of printer list information.

FIG. 15 illustrates a data structure of print job list page information.

FIG. 16 illustrates a data structure of substitute printer list page information.

FIG. 17 illustrates examples of web pages.

FIG. 18 illustrates a flowchart of an operation flow of a web server.

FIG. 19 illustrates a flowchart of an operation flow of a storing job management service.

FIGS. 20A and 20B illustrate a flowchart of an operation flow of a pull-printing application.

FIG. 21 illustrates a flowchart of an operation flow of a pull-printing application.

### DESCRIPTION OF THE EMBODIMENTS

Various exemplary embodiments, features, and aspects of the invention will be described in detail below with reference to the drawings.

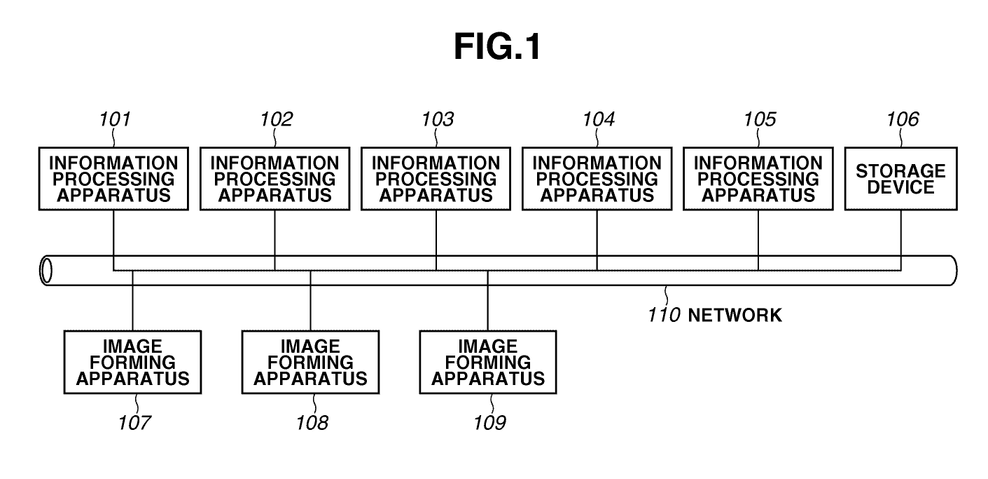

FIG. 1 illustrates a system configuration of a pull-printing system. Referring to FIG. 1, the pull-printing system includes information processing apparatuses 101, 102, 103, 104, and 105, image forming apparatuses 107, 108, and 109, and a storage device 106, which are connected to each other via a network 110.

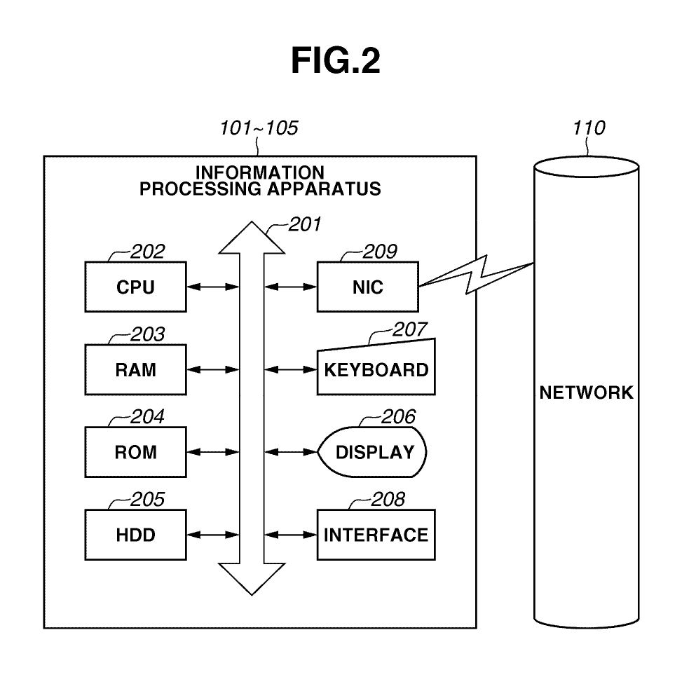

The information processing apparatuses 101, 102, 103, 104, and 105 include a client application (e.g., a web browser) to be used in instructing printing, and programs for storing and managing jobs and information about print settings in the storage device 106. The client application and the programs are in an executable state. According to the present exemplary embodiment, the hardware configurations of the information processing apparatuses 101, 102, 103, 104, and 105 are basically the same (refer to FIG. 2 for details).

For ease of description, the information processing apparatuses 101, 102, 103, and 104, which provide various services other than the client application, will be referred to as a server apparatus. The information processing apparatus 105, which includes the client application, will be referred to as a client terminal. The client terminal is more strictly referred to as a thin-client terminal.

Further, the information processing apparatuses 101, 102, 103, and 104, which provide various services, are not limited to being realized by a plurality of apparatuses and can also be realized by a single apparatus. Furthermore, the information processing apparatuses 101, 102, 103, 104, and 105 are realized by a computer. Moreover, the various programs are stored in a computer-readable storage medium.

The information processing apparatuses 101, 102, 103, and 104 manage user information such as a user name. The information processing apparatuses 101, 102, 103, and 104 further include in executable states an authentication program, and a program for creating storing jobs and registering the storing jobs in the storing job management program.

More specifically, the information processing apparatuses 101, 102, 103, and 104 receive a storing job list acquisition request and an available printer list acquisition request from the client application. The storing job list acquisition request is an instruction to acquire, when a user requests printing via the information processing apparatus 105, a list of information about the print data, which the user is permitted to print (i.e., storing job data to be described below).

The available printer list acquisition request is an instruction to acquire a list of information about the image forming apparatuses 107, 108, and 109, which are available for printing and are permitted to perform printing.

Upon receiving the storing job list acquisition request, the information processing apparatuses 101, 102, 103, and 104 acquire a list of storing jobs managed by a database service 405 (to be described below) and stored in the storage device 106.

Further, the information processing apparatuses 101, 102, 103, and 104 receives a print request from the image forming apparatuses 107, 108, and 109. The information processing apparatuses 101, 102, 103, and 104 then acquire from the storage device 106 the storing job data corresponding to the print request and transmit the storing job data to the image forming apparatuses 107, 108, and 109, which issued the print request.

In other words, the information processing apparatuses 101, 102, 103, and 104 include a function for inputting a print job corresponding to the print request to the image forming apparatuses 107, 108, and 109, which issued the print request.

Furthermore, the information processing apparatuses 101, 102, 103, and 104 record on the storage device 106 the information about progress and result of the print job that is notified from the image forming apparatuses 107, 108, and 109.

Moreover, the information processing apparatuses 101, 102, 103, and 104 create and transmit to a storing job management service 401 (to be described below) storing jobs. The storing job management service 401 manages the storing job data of the storing jobs using the database service 405 included in one of the information processing apparatuses 101, 102, 103, and 104. The storing job data is further stored in the storage device 106.

The storage device 106 is separately configured from the information processing apparatuses 101, 102, 103, and 104. However, the present invention is not limited to the above configuration, and the storage device 106 can be included in the information processing apparatuses 101, 102, 103, and 104. The storage device 106 according to the present exemplary embodiment is realized by an external hard disk drive (HDD).

The image forming apparatuses 107, 108, and 109 include a program for performing pull-printing. The image forming apparatuses 107, 108, and 109 are print devices, i.e., physical apparatuses, which acquire storing job data via the information processing apparatuses 101, 102, 103, and 104, analyze the storing job data, and print the storing job data. According to the present exemplary embodiment, the image forming apparatuses 107, 108, and 109 are realized by a printer (i.e., a printing apparatus).

Printing apparatuses utilizing various methods can be applied as the image forming apparatuses 107, 108, and 109. Examples of such printing apparatuses are a laser beam printer employing an electrophotographic method, an inkjet printer employing an ink jet method, and a printer employing a thermal transfer method.

The user instructs the image forming apparatuses 107, 108, and 109 to print the storing job data via a liquid crystal display (LCD) panel of the image forming apparatuses 107, 108, and 109, or a client application stored in the information processing apparatus 105.

The apparatuses included in the pull-printing system can communicate with each other via a cable (i.e., wired communication) or via radio waves or light (i.e., wireless communication).

FIG. 2 illustrates a hardware configuration of the information processing apparatuses 101, 102, 103, 104, and 105.

Referring to FIG. 2, the information processing apparatuses 101, 102, 103, 104, and 105 include a system bus 201, a central processing unit (CPU) 202, a random access memory (RAM) 203, a read-only memory (ROM) 204, and an HDD 205. The system bus 201 controls the data exchange between the information processing apparatuses 101, 102, 103, 104, and 105 in the pull-printing system.

The CPU 202 controls the entire apparatus. For example, the CPU 202 executes application programs and an operating system (OS) stored in the HDD 205 and performs control to temporarily store in the RAM 203 information and files used for executing the programs.

The RAM 203 functions as a main memory and a work area of the CPU 202. The RAM 203 is an example of a temporary storage unit for temporarily storing various data. The ROM 204 internally stores programs such as a basic input/output (I/O) program, font data to be used in document processing, and various data such as template data. The ROM 204 is thus an example of a storage unit for storing various data.

The HDD 205 is a large-capacity memory. The HDD 205 stores application programs, a web service program, a database program, an authentication service program, a printer driver program, the OS, a network printer control program, and relating programs. The HDD 205 is thus an example of an external storage unit for storing various data.

Further, the information processing apparatuses 101, 102, 103, 104, and 105 include a display 206, a keyboard 207, an interface 208, and a network interface card (NIC) 209. The display 206 displays commands that the user has input using the keyboard 207, and a printer status. The display 206 is thus an example of a display unit for displaying various kinds of information. The keyboard 207 is used by the user to input characters to the information processing apparatuses 101, 102, 103, 104, and 105 by pressing keys. The keyboard 207 is thus an example of an instruction input unit for inputting various instructions.

The interface 208 is an external device interface (I/F) for connecting to a printer, a universal serial bus (USB) device, and a peripheral device. The NIC 209 exchanges data with external devices via the network 110. At least one of the interface 208 and the NIC 209 is an example of a connection unit for connecting to various apparatuses. More specifically, the connection unit connects the image forming apparatuses 107, 108, and 109 and the information processing apparatuses 101, 102, 103, 104, and 105 via a network.

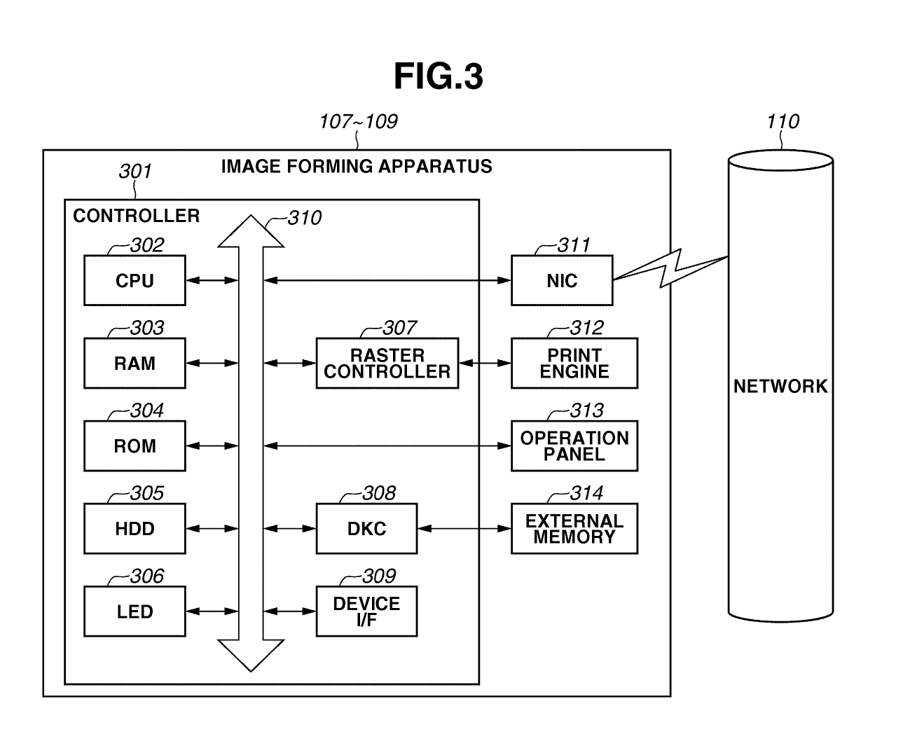

FIG. 3 is a block diagram illustrating a hardware configuration of the image forming apparatuses 107, 108, and 109.

The image forming apparatuses 107, 108, and 109 include a controller 301, a NIC 311, a print engine 312, an operation panel 313, and an external memory 314. The controller 301 for controlling the image forming apparatus includes a CPU 302, a RAM 303, a ROM 304, and an HDD 305.

The CPU 302 controls the entire apparatus. For example, the CPU 302 performs overall control of accessing various devices connected to a system bus 310 to be described below. The CPU 302 performs such control based on a control program stored in the ROM 304, or a control program and resource data (i.e., resource information) stored in an external memory 314 connected via a disk controller (DKC) 308.

The RAM 303 functions as a main memory and a work area of the CPU 302. The memory capacity of the RAM 303 can be expanded by an optional RAM connected to an expansion port (not illustrated).

Since the functions of the ROM 304, the HDD 305, the system bus 310, and the NIC 311 are basically the same as those of the ROM 204, the HDD 205, the system bus 201, and the NIC 209 illustrated in FIG. 2, description will be omitted. The configurations of the CPU 302 and the RAM 303 are also basically the same as those of the CPU 202 and the RAM 203 illustrated in FIG. 2. However, description is not omitted due to importance of the description.

The controller 301 further includes a light emitting diode (LED) 306, a raster controller 307, a DKC 308, and a device I/F 309. The raster controller 307 converts the print data described in a page-description language (PDL) or in a portable document format (PDF) into image data. The device I/F 309 is an interface to external devices connectable via the USB and functions similarly as the interface 208.

The print engine 312 uses a known printing technique, such as the electrophotographic method (e.g., laser beam method), the inkjet method, and a sublimation method (e.g., heat transfer method).

The operation panel 313 is a device used by the user to operate the image forming apparatus to perform pull-printing, i.e., an operation unit. A user interface and a pull printing switching button for operating to perform pull-printing are disposed in the operation panel 313. Further, the operation panel 313 includes buttons for setting an operation mode of the image forming apparatuses 107, 108, and 109, displaying the operation statuses thereof, and instructing copying. The operation panel 313 also includes a display unit such as the LCD panel and the LED 306. The external memory 314 is an example of a storage unit for storing various data.

The present invention is not limited to the above-described examples of hardware configurations illustrated in FIGS. 2 and 3. For example, data and programs can be stored in either of the ROM, the RAM, and the HDD, according to the features thereof.

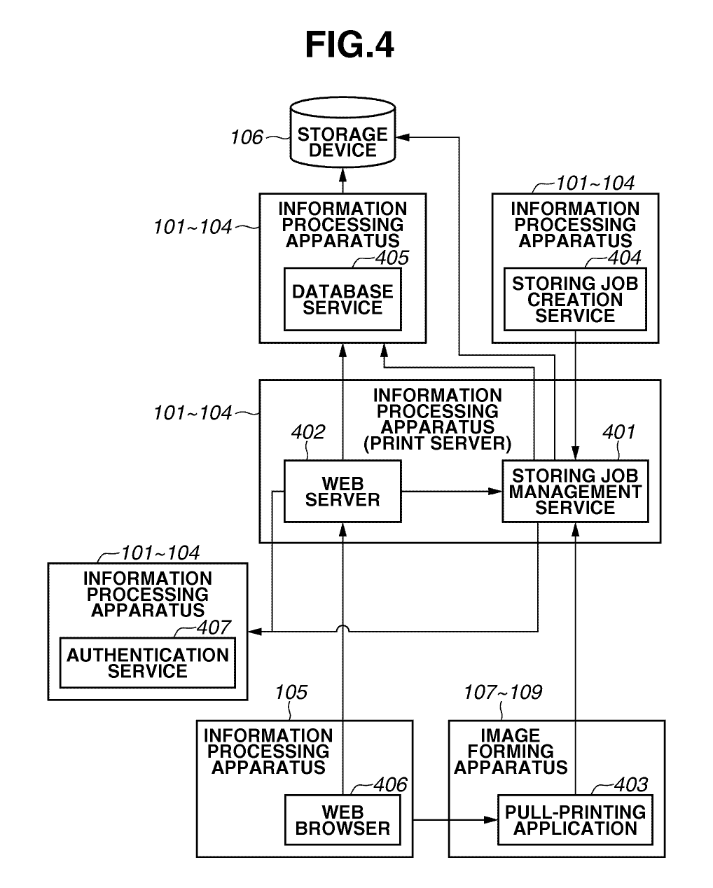

FIG. 4 is a block diagram illustrating an example of a functional configuration of each apparatus included in the pull-printing system.

Referring to FIG. 4, the information processing apparatuses 101, 102, 103, and 104 include the storing job management service 401, a web server 402, a storing job creation service 404, the database service 405, and an authentication service 407. The storing job management service 401 included in one of the information processing apparatuses 101, 102, 103, and 104 receives a storing job from the storing job creation service 404. The storing job management service 401 then registers the received storing job in the database service 405 included in one of the information processing apparatuses 101, 102, 103, and 104.

Upon receiving a login request from a web browser 406 in the information processing apparatus 105, the web server 402 in one of the information processing apparatuses 101, 102, 103, and 104 inquires the authentication service 407 and performs authentication. The authentication service 407 is included in one of the information processing apparatuses 101, 102, 103, and 104. Further, upon receiving the storing job list acquisition request by a user operation on the web browser 406, the web server 402 acquires a list of storing jobs that are accessible by a user who has been authenticated from the database service 405. The web server 402 then sends a response to the web browser 406.

Further, upon receiving the available printer list acquisition request, the web server 402 searches for and acquires from the database service 405 a list of available printers. Such printers are available for printing the storing job that is designated in the available printer list acquisition request and are accessible by the user who has been authenticated. The web server 402 then sends a response to the web browser 406.

The storing job creation service 404 included in one of the information processing apparatuses 101, 102, 103, and 104 creates the storing jobs. The storing job creation service 404 transmits the storing jobs to the storing job management service 401 regularly or at timing designated by the user.

The database service 405 stores the storing job information in the storage device 106. Further, the storing job management service 401 stores the storing job in the storage device 106 as the storing job data. The storing job data is form data including data designated by the user, and printable data created by a document creation application.

The authentication service 407 checks whether the user information about the user who operates the web browser 406 matches the user information registered in the authentication service 407.

The image forming apparatuses 107, 108, and 109 include a pull-printing application 403. Upon receiving a print instruction from the web browser 406, the pull-printing application 403 acquires the storing job data corresponding to the print instruction via the storing job management service 401 and prints the acquired data.

Further, the pull-printing application 403 returns to the web browser 406 as appropriate a web page that describes a status of the job that is being printed, and a substitute printer list to be used when an error has occurred. The pull-printing application 403 includes an interface to a web service.

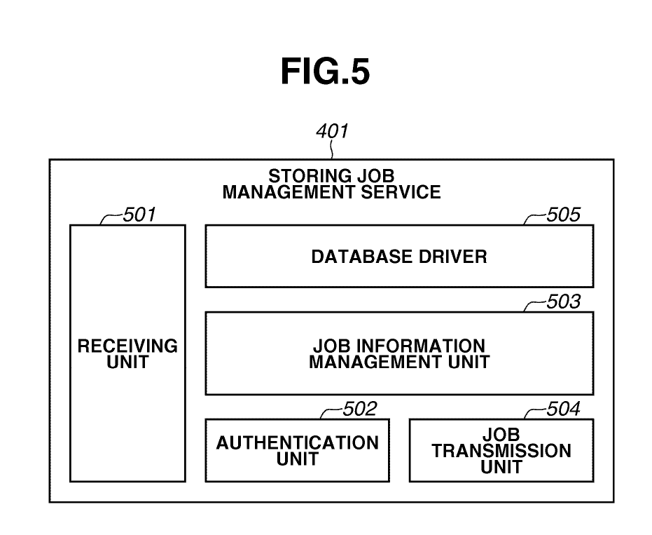

FIG. 5 is a block diagram illustrating a configuration of the storing job management service 401 in one of the information processing apparatuses 101, 102, 103, and 104.

Referring to FIG. 5, the storing job management service 401 includes a receiving unit 501, an authentication unit 502, a job information management unit 503, a job transmission unit 504, and a database driver 505. The receiving unit 501 receives the print request from the pull-printing application 403 and the storing job transmitted from the storing job creation service 404.

When the receiving unit 501 receives the print request from the pull-printing application 403, the authentication unit 502 inquires the authentication service 407 whether the request is valid. In other words, the authentication unit 502 inquires the authentication service 407 whether the request is received from a user who has been authenticated.

When the receiving unit 501 receives the storing job, the job information management unit 503 registers the storing job information in the database service 405 via the database driver 505. The job information management unit 503 then stores the storing job data in the storage device 106.

Further, when the receiving unit 501 receives the print request from the pull-printing application 403, the job information management unit 503 acquires the storing job information from the database service 405. The job information management unit 503 also acquires the storing job data corresponding to the printing request from the storage device 106.

Furthermore, when the receiving unit 501 receives the print request from the pull-printing application 403, the job transmission unit 504 transmits the storing job to the image forming apparatuses 107, 108, and 109.

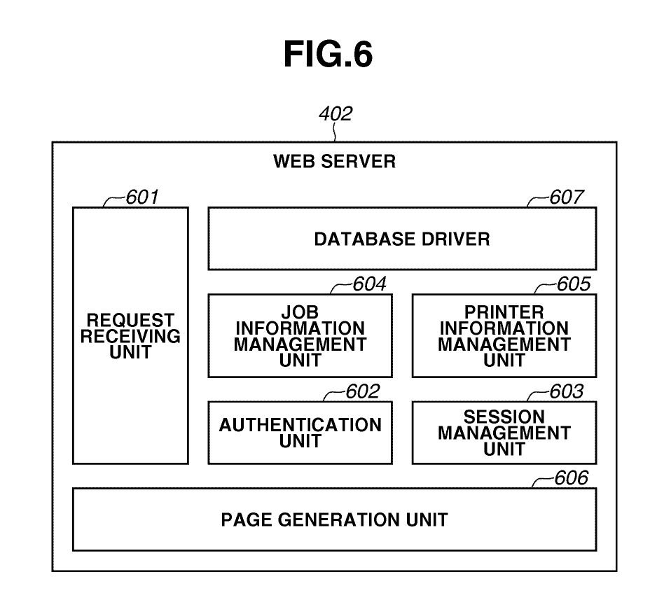

FIG. 6 is a block diagram illustrating the configuration of the web server 402 in one of the information processing apparatuses 101, 102, 103, and 104.

The web server 402 includes a request receiving unit 601, an authentication unit 602, a session management unit 603, a job information management unit 604, a printer information management unit 605, a page generation unit 606, and a database driver 607.

The request receiving unit 601 receives the login request, the storing job list acquisition request, and the available printer list acquisition request from the web browser 406 in the information processing apparatus 105. If the request receiving unit 601 receives the login request from the web browser 406, the authentication unit 602 inquires the authentication service 407 whether the login request is valid.

If the authentication unit 602 authenticates the user, the session management unit 603 creates and manages session information of the request. Further, if the request receiving unit 601 receives the storing job list acquisition request from the web browser 406, the job information management unit 604 acquires the storing job information from the database service 405 via the database driver 607.

Furthermore, if the request receiving unit 601 receives the available printer list acquisition request from the web browser 406, the printer information management unit 605 acquires the printer information from the database service 405 via the database driver 607. The page generation unit 606 generates a page in response to each request received from the web browser 406 and transmits the page to the information processing apparatus 105.

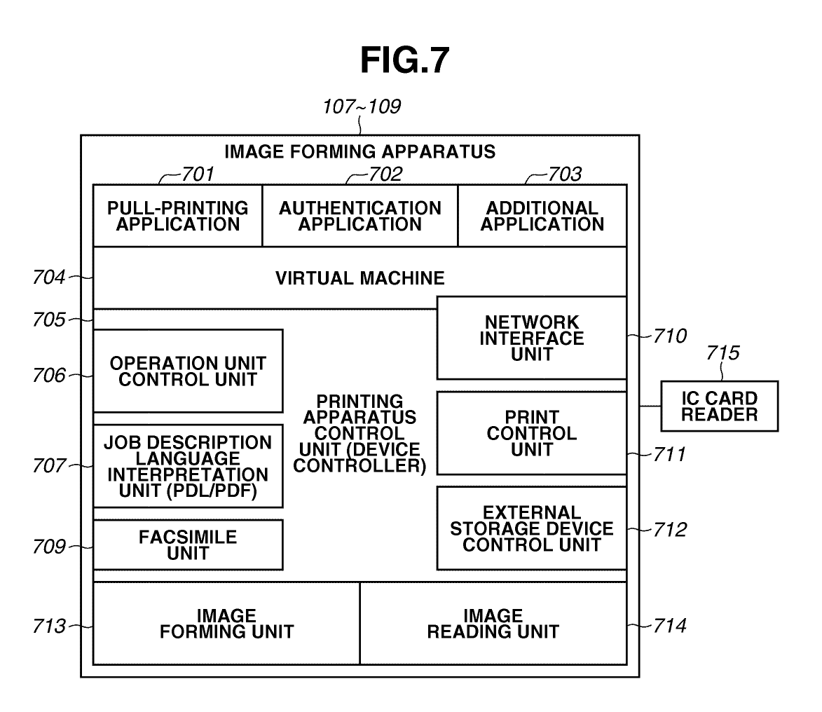

FIG. 7 illustrates a configuration of the image forming apparatuses 107, 108, and 109.

The image forming apparatuses 107, 108, and 109 include a pull-printing application 701, an authentication application 702, an additional application 703, a virtual machine 704, and a device controller 705. Further, the image forming apparatuses 107, 108, and 109 include an image forming unit 713 and an image reading unit 714.

The virtual machine 704 is located above the device controller 705, and the user can control the device controller 705 using the virtual machine 704. Further, applications, which are described in a programming language in compliance with application programming interfaces (API) provided by the virtual machine 704, are located above the virtual machine 704.

Such applications can indirectly invoke the device controller 705 via the virtual machine 704, so that the image forming unit 713 and the image reading unit 714 are caused to perform the operations.

The device controller 705 controls each of the operations of the image forming unit 713 and the image reading unit 714. For example, the device controller 705 controls the image forming unit 713 to copy document information read by the image reading unit 714. Further, the device controller 705 includes an operation unit control unit 706, a job description language interpretation unit 707, a facsimile unit 709, a network interface unit 710, a print processing unit 711, and an external storage device control unit 712. The device controller 705 controls information exchange between such units.

The operation unit control unit 706 generates a signal according to a user operation on the operation panel, i.e., an operation unit, and performs control to display various data and messages on the operation unit and the display unit. The job description language interpretation unit 707 interprets PDL, PDF, and other print job description languages and coverts the print job into image data.

The facsimile unit 709 transmits and receives facsimile images. More specifically, the facsimile unit 709 transmits digital image information read by the image reading unit 714, decodes a received facsimile signal, and records the decoded facsimile signal using the image forming unit 713.

The network interface unit 710 controls reception and transmission of data from and to other communication terminals via a communication line. Further, both the device controller 705 and the virtual machine 704 can directly use the network interface unit 710, so that the device controller 705 and the virtual machine 704 can independently access the external network. The print processing unit 711 controls processing of the print job input via the network interface 710, outputting of the result to the image forming unit 713, and printing.

The external storage device control unit 712 converts, using the image forming unit 713, the image read by the image reading unit 714 into a data format that can be stored in the external storage device. The external storage device control unit 712 then stores the converted image in the external storage device. Further, the external storage device control unit 712 reads out the data stored in the external storage device and prints the data via the image forming unit 713 or transmits the data to outside via the network interface unit 710.

The image forming unit 713 performs a series of image forming processes including paper handling, image transfer, and fixing, and forms the image on a recording medium such as a recording paper. The image forming unit 713 includes an image forming device, for example, an image forming unit of an inkjet printer or of an electrophotographic method.

The image reading unit 714 including a scanner optically reads a document image and converts the read image into digital image information. Further, the image reading unit 714 outputs the digital image information to the image forming unit 713 to form an image and transmits the digital information via the network using the facsimile unit 709 and the network interface unit 710.

Furthermore, according to the present exemplary embodiment, an integrated chip (IC) card reader 715 is connected to the image forming apparatuses 107, 108, and 109 for the user to directly log into the image forming apparatuses 107, 108, and 109. Account information of the user can thus be notified to the authentication application 702 via the IC card reader 715.

Login units other than the IC card reader can be used, for example, an identification (ID) card reader or an input from a device panel managed by the operation unit control unit 706.

According to the present exemplary embodiment, applications such as the pull-printing application 701 and the authentication application 702 can be uninstalled from the virtual machine 704. Further, applications can be newly installed as the additional application 703.

Furthermore, according to the present exemplary embodiment, the above-described applications are installed in the image forming apparatuses 107, 108, and 109. However, the applications can also be installed in hardware. Moreover, the above-described applications can be included in a computer, which is communicably connected to the image forming apparatuses 107, 108, and 109 as an external device.

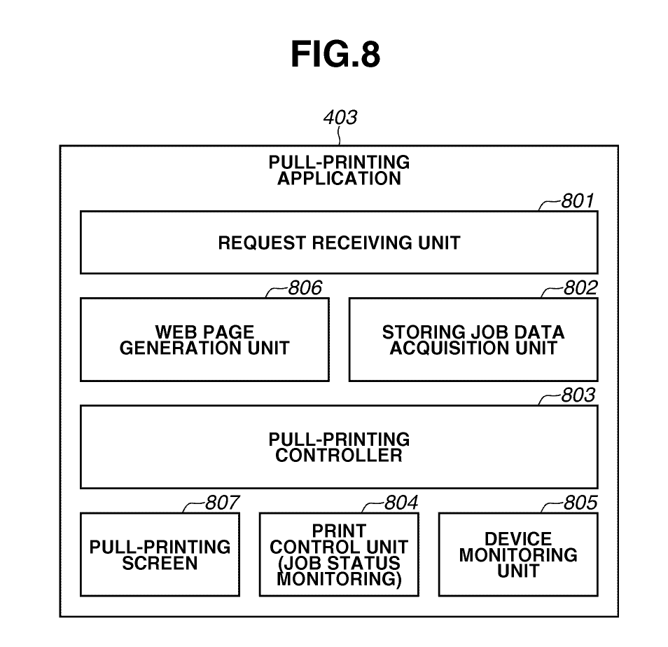

FIG. 8 is a block diagram illustrating the pull-printing application 403 in the image forming apparatuses 107, 108, and 109.

The pull-printing application 403 includes a request receiving unit 801, a storing job data acquisition unit 802, a pull-printing controller 803, a print control unit 804, a device monitoring unit 805, a web page generation unit 806, and a pull-printing screen 807. When the web browser 406 in the information processing apparatus 105 transmits the print request or the job status update request to the pull-printing application 403, the request receiving unit 801 receives the request. Then, the request receiving unit 801 transfers the processing to the pull-printing controller 803.

The pull-printing controller 803 instructs the storing job data acquisition unit 802 to receive the print request from the request receiving unit 801. The storing job data acquisition unit 802 then transmits to the storing job management service 401 in one of the information processing apparatuses 101, 102, 103, and 104 a job identification (ID) and authentication information of the storing job. The storing job data acquisition unit 802 thus acquires the storing job data requested in the print request.

The pull-printing controller 803 receives via the request receiving unit 801 a request from an external component (e.g., the web browser 406). Further, the pull-printing controller 803 receives via the pull-printing screen 807 a request that the user inputs to the operation panel 313 of the image forming apparatuses 107, 108, and 109.

The pull-printing controller 803 also instructs the print control unit 804 to receives the print request via the request receiving unit 801. The print controller unit 804 then transmits the storing job data acquired by the storing job data acquisition unit 802 to the print processing unit 711 and performs control to execute printing. Further, the pull-printing controller 803 instructs the print control unit 804 to receive the job status updating request via the request receiving unit 801. The print control unit 804 then confirms the print status of the job acquired from the print processing unit 711 and transmits the status information to the web page generation unit 806.

Furthermore, when the request receiving unit 801 receives the printer status acquisition request, the print control unit 804 acquires the status information of the image forming apparatuses 107, 108, and 109. The pull-printing controller 803 stores the status information in the device monitoring unit 805. The print control unit 804 then transmits the status information to the web page generation unit 806.

The device monitoring unit 805 acquires from the print control unit 804 and stores the status information of the image forming unit 107, 108, and 109. The status information is updated when the status of the apparatuses changes. The web page generation unit 806 generates a page in response to the request based on the acquired information and then transmits the page to the web browser 406.

The pull-printing screen 807 displays the storing jobs accessible by the user. In other words, the pull-printing screen 807 displays the storing jobs managed by the storing job management service 401, so that the user can instruct printing of the storing jobs.

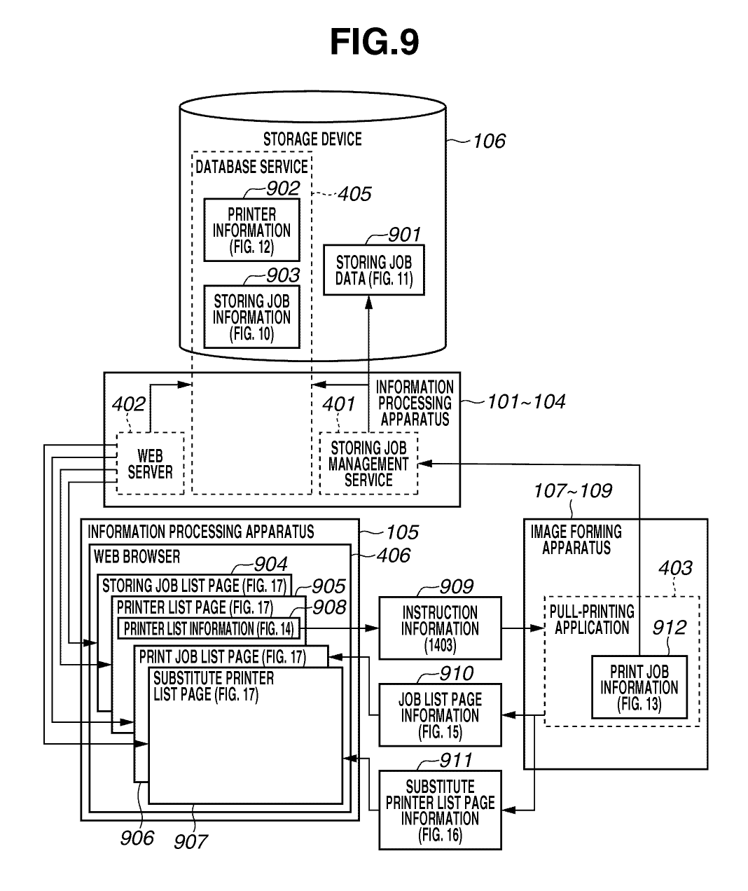

FIG. 9 illustrates each data and the flow of each data in the pull-printing system.

Referring to FIG. 9, the storage device 106 basically stores printer information 902, storing job information 903, and storing job data 901 managed by the database service 405 in one of the information processing apparatuses 101, 102, 103, and 104. The storing job management service 401 registers the storing job information 903 and the storing job data 901 when storing the storing job data.

Further, the web browser 402 refers to the storing job information 903 and the printer information 902 when the storing job list acquisition request or the printer list acquisition request is received from the web browser 406 in the information processing apparatus 105.

A storing job list page 904 is an example of a page, which is created in response to the storing job list acquisition request. A printer list page 905 is an example of a page, which is created in response to the printer list acquisition request. Printer list information 908 is detailed information to be included in the printer list page 905. Instruction information 909 is transmitted from the web browser 406 when the web browser 406 transmits the print request to the pull-printing application 403.

Print job information 912 is stored inside the pull-printing application 403 in the image forming apparatuses 107, 108, and 109 when the pull-printing application 403 starts printing. Print job list page information 910 is utilized when the web browser 406 issues the print status update request. In such a case, the pull-printing application 403 refers to the print job information 912 and then transmits the print job list page information 910 to the information processing apparatus 105. A print job list page 906 is thus displayed by the web browser 406 as an example of a response page.

Substitute printer list page information 911 is transmitted to the web browser 406 when the pull-printing application 403 determines that an error has occurred in printing the job and substitute printing is to be performed. The web browser 406 then displays a substitute printer list page 907 as an example of a response page.

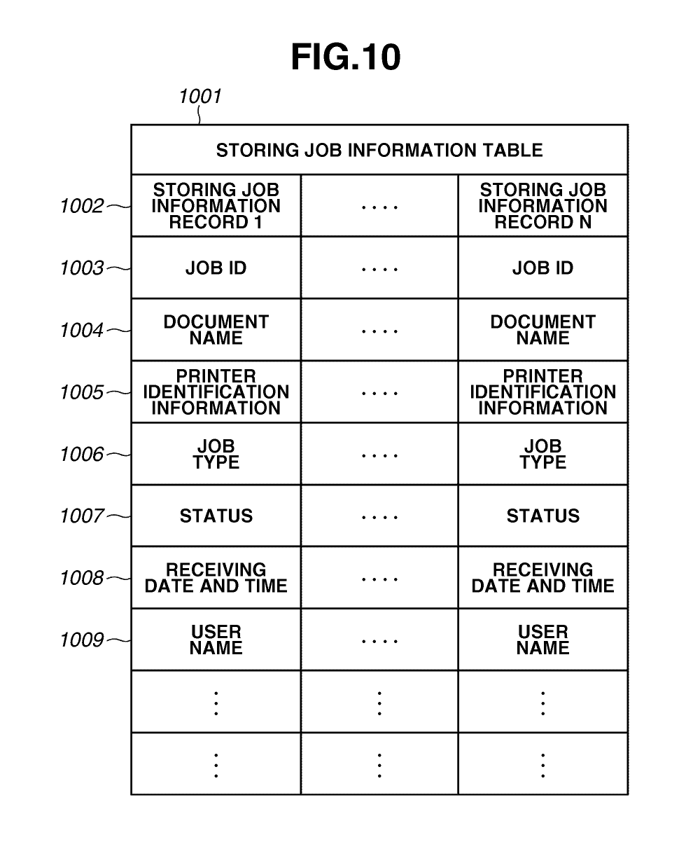

FIG. 10 illustrates an example of configurations of a storing job information table and records, which the database service 405 stores and manages in the storage device 106.

Referring to FIG. 10, a storing job information table 1001 for storing the storing job information includes a plurality of job information records 1002. The job information record 1002 includes a job ID 1003, a document name 1004, printer identification information 1005, a job type 1006, a status 1007, a receiving date and time 1008, and a user name 1009.

The job ID 1003 is an identifier (hereinafter to be referred to as an ID) for uniquely identifying the storing job in the pull-printing system. The document name 1004 is a title of the storing job. The printer identification information 1005 is information for identifying the image forming apparatuses 107, 108, and 109 that is printing.

Upon receiving the storing job list acquisition request from the image forming apparatuses 107, 108, and 109, the information processing apparatuses 101, 102, 103, and 104 transmit the requested storing job thereto. The information processing apparatuses 101, 102, 103, and 104 use an internet protocol (IP) address and a host name of the image forming apparatuses 107, 108, and 109 as the printer identification information 1005 in transmitting the requested storing job.

The job type 1006 indicates a type of the description language of the storing job, such as PDL, PDF, and form description language. The status 1007, which indicates the status of the print job, includes status information such as “waiting”, “printing”, “normal end”, and “error end”.

The receiving date and time 1008 indicates the date and time when the storing job creation service 404 registered the storing job in the storing job management service 401 which then stored the storing job in the database service 405.

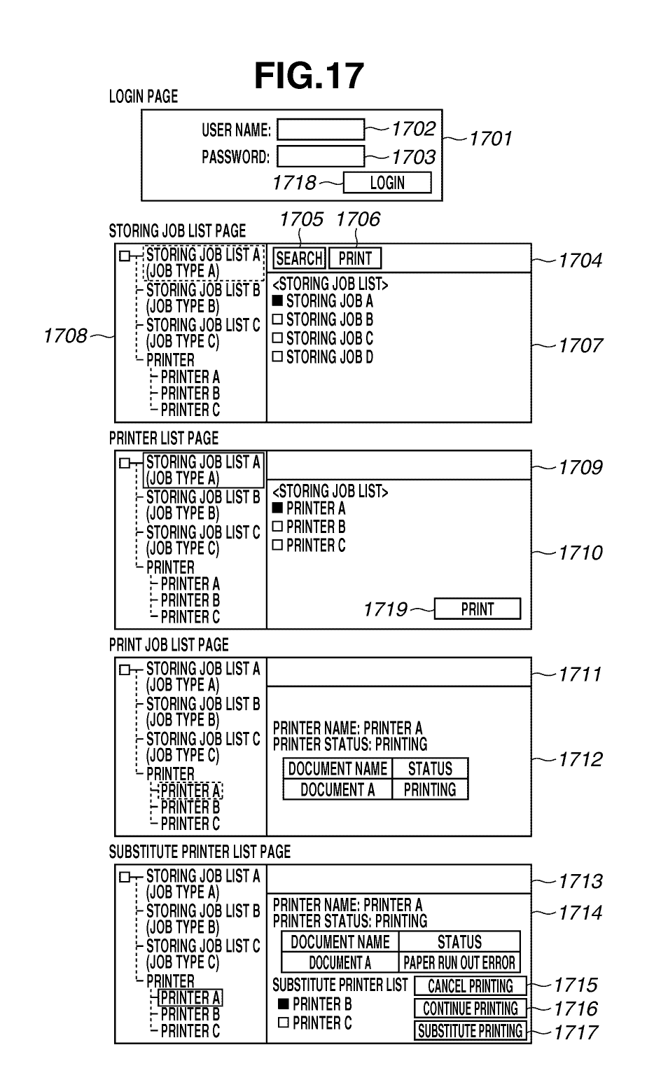

The user name 1009 is information indicating an owner of the storing job. For example, if the web browser 406 issues the storing job acquisition request, the web server 402 returns to the web browser 406 the job information matching the user who is authenticated by the authentication service 407. The user can thus access such job information on the web browser 406. Examples of the pages displayed on the web browser 406 will be described in detail below with reference to FIG. 17.

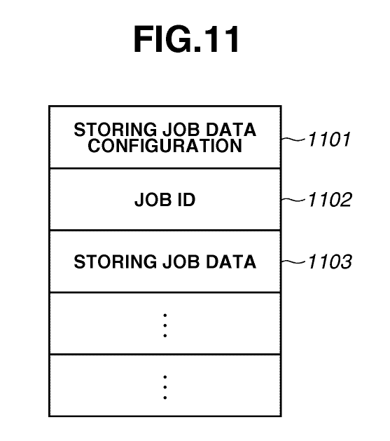

FIG. 11 illustrates a configuration of the storing job data, which the database service 405 stores and manages in the storage device 106.

Referring to FIG. 11, a storing job data configuration 1101 includes a job ID 1102 for uniquely identifying the print job in the pull-printing system, and storing job data 1103.

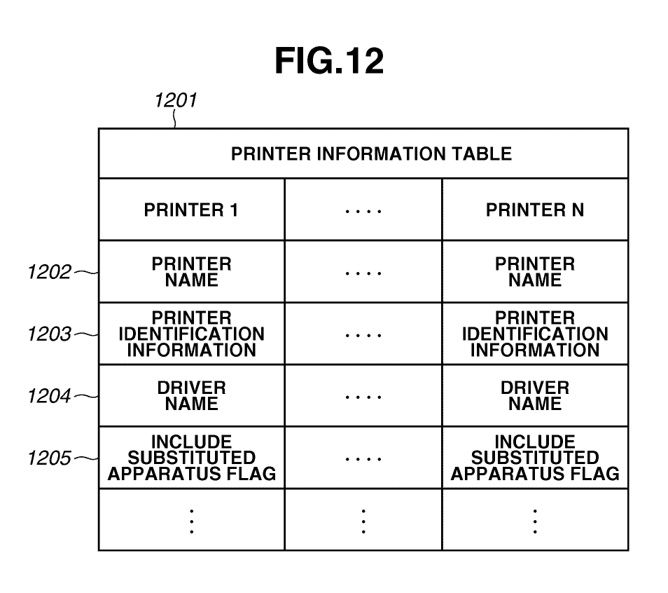

FIG. 12 illustrates a printer information table that the database service 405 stores and manages in the storage device 106.

Referring to FIG. 12, a printer information table 1201 stores information about a plurality of printers as records. Each record includes a printer name 1202, printer identification information 1203, a driver name 1204, and an “include substituted printer” flag 1205.

The printer name 1202 indicates the name of each of the image forming apparatuses 107, 108, and 109 in the pull-printing system. The printer identification information 1203 is information for identifying the printer on the network, such as the IP address and the host name of each of the image forming apparatuses 107, 108, and 109. The driver 1204 indicates a name of the driver to be used when the storing job data is converted into data that can be printed on the print system.

The “include substituted printer” flag 1205 is a flag for determining, when a printing error has occurred and the pull-printing application 403 creates the substitute printer list, whether to create the list including the apparatus in which the error has occurred.

If the “include substituted printer” flag 1205 is set, the pull-printing application 403 creates the substitute printer list by including the apparatus in which the error has occurred. On the other hand, if the “include substituted printer” flag 1205 is not set, the pull-printing application 403 creates the substitute printer list without including the apparatus in which the error has occurred.

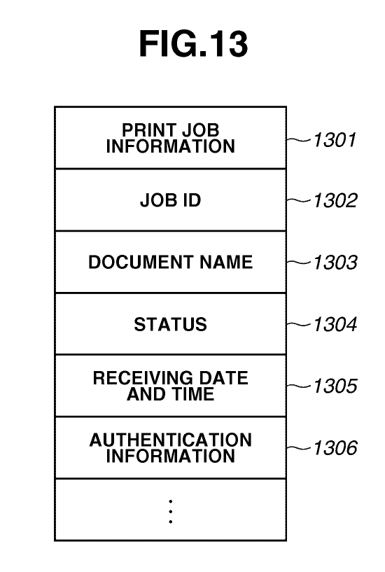

FIG. 13 illustrates a data structure of the information about the print job stored by the pull-printing application 403 when performing printing.

Referring to FIG. 13, print job information 1301 includes a job ID 1302, a document name 1303, a status 1304, a receiving date and time 1305, and authentication information 1306. The job ID 1302 is an ID for uniquely identifying the job. The document name 1303 is the name of the document to be a subject of the print job.

The status 1304 indicates the print status. The status 1304 becomes “transferring” from when the pull-printing application 403 acquires the storing job data configuration 1101 via the storing job management service 401 to when the pull-printing application 403 receives the job. The status 1304 then becomes “transferred” when the pull-printing application 403 receives the job. Further, the status 1304 becomes “printing” when the pull-printing application 403 starts printing, and becomes “normal end” or “error end” to indicate the result when the pull-printing application 403 ends printing.

The receiving date and time 1305 indicates the date and time when the pull-printing application 403 has received the print request from the web browser 406. The authentication information 1306 is information indicating the authentication result acquired by the authentication service 407 when the web server 402 requested authentication to the authentication service 407 after receiving the login request from the web browser 406.

More specifically, information about the authentication result includes identification information indicating the authenticated user (e.g., user name, user ID, and password) and the session information generated by the web server 402.

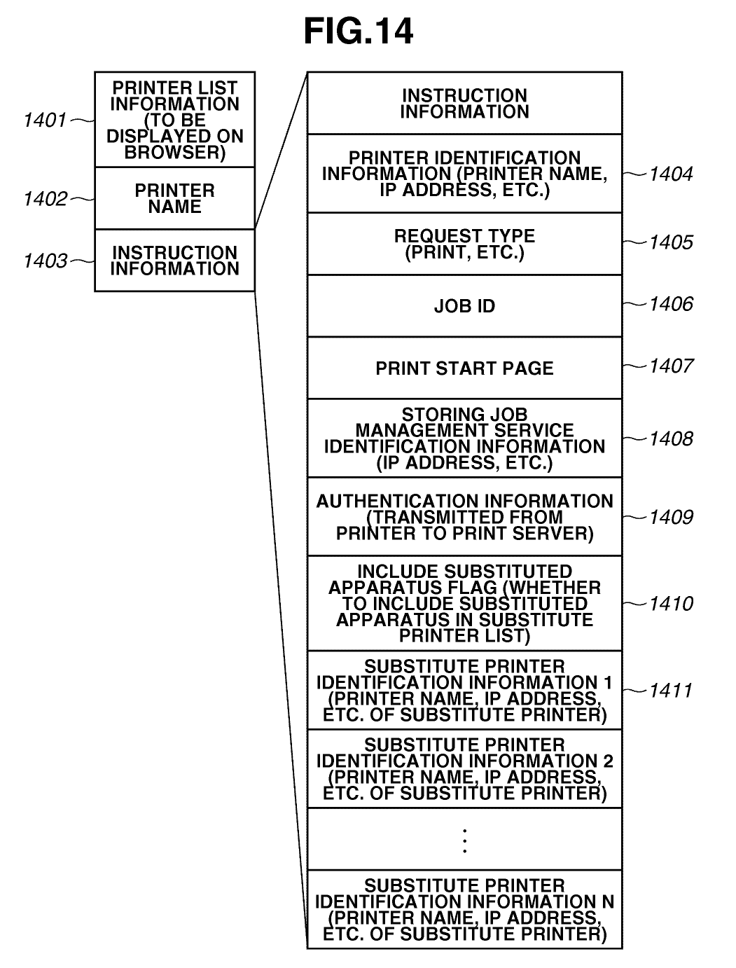

FIG. 14 illustrates a data structure of printer list information included in a printer list page 1709 illustrated in FIG. 17 (to be described below), which is displayed on the web browser 406.

Referring to FIG. 14, printer list information 1401 includes a printer name 1402 and instruction information 1403. The printer list information 1401 is generated based on the information acquired from the web server 402, such as the information in the printer information table 1201 acquired by the web server 402 from the database service 405.

The printer name 1402 indicates the name of the image forming apparatuses 107, 108, and 109 in the pull-printing system. The instruction information 1403 is information transmitted from the web browser 406 to the pull-printing application 403 together with the print request. The instruction information 1403 is transmitted from the web browser 406 in a format such as a uniform resource locator (URL) or a web service interface.

The instruction information 1403 includes printer identification information 1404, a request type 1405, a job ID 1406, a print start page 1407, and storing job management service identification information 1408.

The printer identification information 1404 is information with which one of the image forming apparatuses 107, 108, and 109 to perform printing can be uniquely identified in the network, including the IP address, the host name, and the printer name 1402. The request information 1405 is the type of request that can be received by the pull-printing application 403, such as “print” and “print cancel” instructions. The job ID 1406 is an ID for identifying the storing job to be printed.

The print start page 1407 is a page in the storing job from which printing is to be started and is basically indicated by a number. The pull-printing application 403 issues a print request to the print processing unit 711 to print from the page indicted by the number. The storing job management service identification information 1408 is information for uniquely identifying the storing job management service 401 in the network, such as the IP address and the host name. The pull-printing application 403 uses the storing job management service identification information 1408 to notify the storing job management service 401 of completion of acquiring the storing job data or printing.

The instruction information 1403 further includes authentication information 1409, “include substituted printer” flag 1410, and substitute printer identification information 1411.

The authentication information 1409 is information similar to the authentication information 1306 in the print job information illustrated in FIG. 13. Further, the “include substituted printer” flag 1410 is a flag similar to the “include substituted printer” flag 1205 in the printer information record illustrated in FIG. 12. The substitute printer identification information 1411 is information on the image forming apparatuses 107, 108, and 109, which are accessible by the user who is authenticated by the web server 402 when the login request is received. The substitute printer identification information 1411 uniquely identifies the image forming apparatus in the network and includes the IP address, the host name, and the printer name 1402.

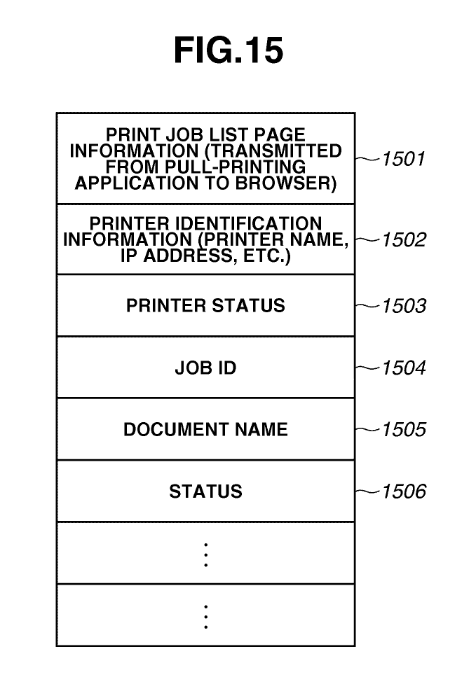

FIG. 15 illustrates a data structure of the print job list page information included in the print job list page 1711 illustrated in FIG. 17 (to be described below), which is displayed on the web browser 406.

Referring to FIG. 15, print job list page information 1501 includes printer identification information 1502, a printer status 1503, a job ID 1504, a document name 1505, and a status 1506. The print job list page information 1501 is data stored in a format that can be interpreted by the web browser 406. The print job list page information 1501 is created by the web page generation unit 806 in the pull-printing application 403.

The printer identification information 1502 is information by which the image forming apparatuses 107, 108, and 109 performing printing can be uniquely identified in the network. The printer identification information 1502 includes the IP address, the host name, and the printer name 1402.

The printer status 1503 indicates the status of the image forming apparatuses 107, 108, and 109, which is acquired by the device monitoring unit 805. The job ID 1504 is an ID for uniquely identifying the job being printed. The document name 1505 is the name of the document of the print job data that is b being printed. The status 1506 indicates the print execution status of the storing job data, which is equivalent to the information stored in the status 1304 in the print job information 1301 illustrated in FIG. 13.

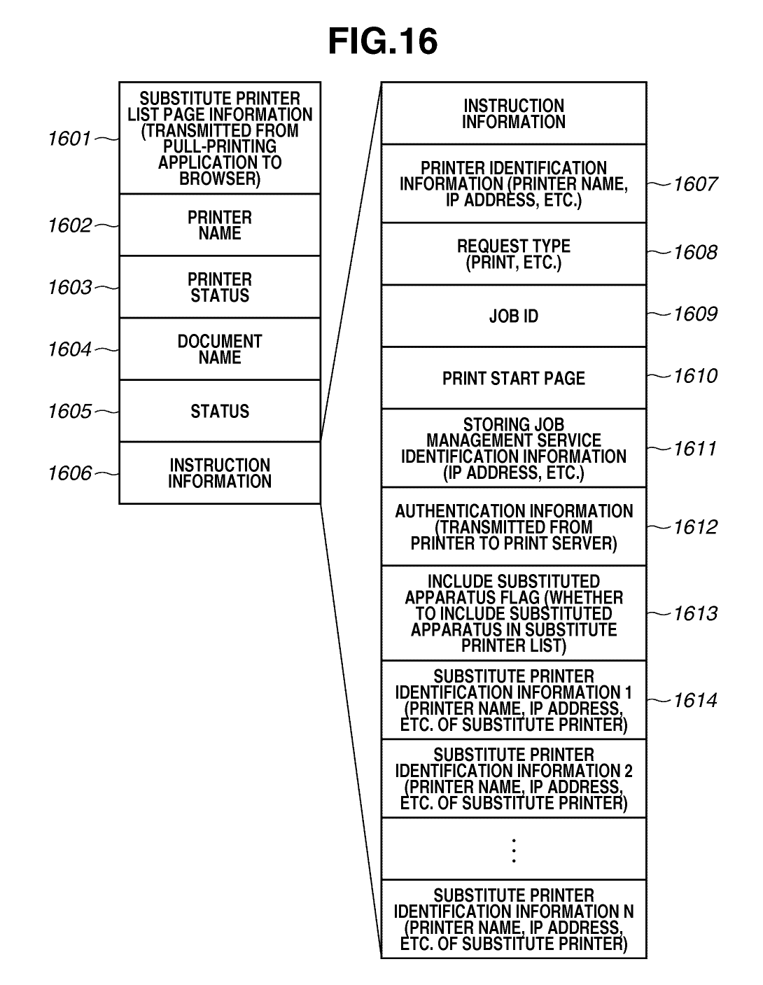

FIG. 16 illustrates a data structure of the substitute printer list page information generated by the pull-printing application 403 and displayed on the web browser 406 when there is a printing error.

Referring to FIG. 16, substitute printer list page information 1601 includes a printer name 1602, a printer status 1603, a document name 1604, a status 1605, and instruction information 1606.

The substitute printer list page information 1601 is generated by the pull-printing application 403 based on the instruction information 1403 transmitted together with the print request from the web browser 406 to the pull-printing application 403. The printer name 1602 is similar to the printer name 1402 in the printer list information 1401 illustrated in FIG. 14.

Further, the printer status 1603, the document name 1604, and the status 1605 are similar to the printer status 1503, the document name 1505, and the status 1506 respectively in the print job list page information 1501 illustrated in FIG. 15.

Furthermore, the instruction information 1606 (including each of information 1607, 1608, 1609, 1610, 1611, 1612, 1613, and 1614) is similar to the instruction information 1403 (including each of the information 1404, 1405, 1406, 1407, 1408, 1509, 1410, and 1411) in the printer list information illustrated in FIG. 14. However, if the “include substituted printer” flag 1613 is set, the substitute printer identification information 1614 includes the identification information on the apparatus in which the error has occurred. On the contrary, if the “include substituted printer” flag 1613 is not set, the substitute printer identification information 1614 does not include the identification information on the apparatus in which the error has occurred.

In other words, the image forming apparatuses 107, 108, and 109 include a setting unit (e.g., the pull-printing application 403). The setting unit sets whether to include in the substitute printer list information the information indicating that the image forming apparatuses 107, 108, and 109 in which the printing error has occurred can perform substitute printing. According to the present exemplary embodiment, the substitute printer list page information 1601 is employed as an example of the substitute printer list information.

Further, according to the present exemplary embodiment, the information indicating that the “include substituted printer” flag 1613 is set is employed as an example of the information indicating that the image forming apparatuses 107, 108, and 109 in which the printing error has occurred can perform substitute printing. As a result, if the image forming apparatuses 107, 108, and 109 in which the printing error has occurred becomes available for printing, printing can be start again or be continued therein.

FIG. 17 illustrates examples of web pages displayed on the web browser 406.

Referring to FIG. 17, a login page 1701 is a page in which the user inputs login information. When the user presses a login button 1718, the login request is transmitted from the web browser 406 to the web server 402 in one of the information processing apparatuses 101, 102, 103, and 104. A user name 1702 and a password 1703 are information that the web browser 406 transmits to the web server 402 along with the login request.

The web server 402 then transmits the information to the authentication service 407 to perform authentication. The information is included in the authentication information 1409 in the instruction information 1403 illustrated in FIG. 14 and the authentication information 1306 in the print job information 1301 illustrated in FIG. 13 stored by the pull-printing application 403.

Each of the pages displayed after the user has logged in includes a tree area 1708 and list areas 1707, 1710, 1712, and 1714. The displayed pages are the storing job list page, the printer list page, the print job list page, and the substitute printer list page. The tree area 1708 classifies in a tree form and displays the storing jobs, or displays the print jobs for processed by each printer. The list areas 1707, 1710, 1712, and 1714 each display a content of each list.

A storing job list page 1704 displays a list of storing jobs accessible by a login user (i.e., an authenticated user), which the web server 402 has acquired from the database service 405. Upon receiving the storing job list acquisition request from the web browser 406, the web server 402 transmits the storing job list page 1704 in response to the web browser 406. A search button 1705 is used by the user to designate a search refinement condition for each of the information of the storing job displayed in the list to search for the desired storing job.

A printer list page 1709 displays a list of the image forming apparatuses 107, 108, and 109, which can print the storing job. According to the present exemplary embodiment, the user selects the storing job to be printed on the storing job list page 1704. The user then presses a print button 1706, and the web browser 406 transmits the job ID 1003 of the selected storing job to the web server 402. The web server 402 acquires from the database service 405 the printer information, which indicates the image forming apparatuses that can print the storing job identified by the transmitted job ID 1003.

The web server 402 then transmits the acquired printer information as the printer list page 1709 in response to the web browser 406. Further, if the user selects the printer to perform printing on a printer list 1710 and presses a print button 1719, the web browser 406 transmits the instruction information 1403 to the pull-printing application 403. Such pull-printing application 403 is stored inside the image forming apparatuses 107, 108, and 109, which can be identified by the printer identification information 1404.

A print job list page 1711 indicates a print status of the storing job instructed to be printed. The pull-printing application 403 creates the print job list page information 1501 illustrated in FIG. 15 based on the print job information 1301 illustrated in FIG. 13. The pull-printing application 403 then transmits the print job list page information 1501 to the web browser 406, which displays the print job list 1712 based on the received print job list page information 1501.

A substitute printer list page 1713 is a list of image forming apparatuses 107, 108, and 109, which are substitute printers. When a printing error has occurred, the pull-printing application 403 creates the substitute printer list 1714 as the substitute printer list page information 1601. The substitute printer list 1714 is then transmitted to the web browser 406, which displays the printer list page 1713 based on the received substitute printer list 1714.

If the user presses a substitute printing button 1717 while selecting the image forming apparatuses 107, 108, and 109 to be the substitute printer from the substitute printer list 1714, the web browser 406 issues a substitute print request including the instruction information 1606. The substitute print request is issued to the pull-printing application 403 in the image forming apparatuses 107, 108, and 109 that can be identified by the printer identification information 1607.

In other words, the information processing apparatus 105 includes a substitute destination selection receiving unit (e.g., the web browser 406). The substitute destination selection receiving unit receives the result of selecting the image forming apparatuses 107, 108, and 109, which is to perform substitute printing based on the substitute printer list information. According to the present exemplary embodiment, the substitute printer list page information 1601 is employed as an example of the substitute printer list information.

Further, if the user presses a cancel printing button 1715, the web browser 406 transmits a print cancel request to the pull-printing application 403 in the image forming apparatus that has transmitted the substitute printer list page 1713.

Furthermore, if the user presses a continue printing button 1716, the web browser 406 transmits a print continue request to the pull-printing application 403 in the image forming apparatus that has transmitted the substitute printer list page 1713.

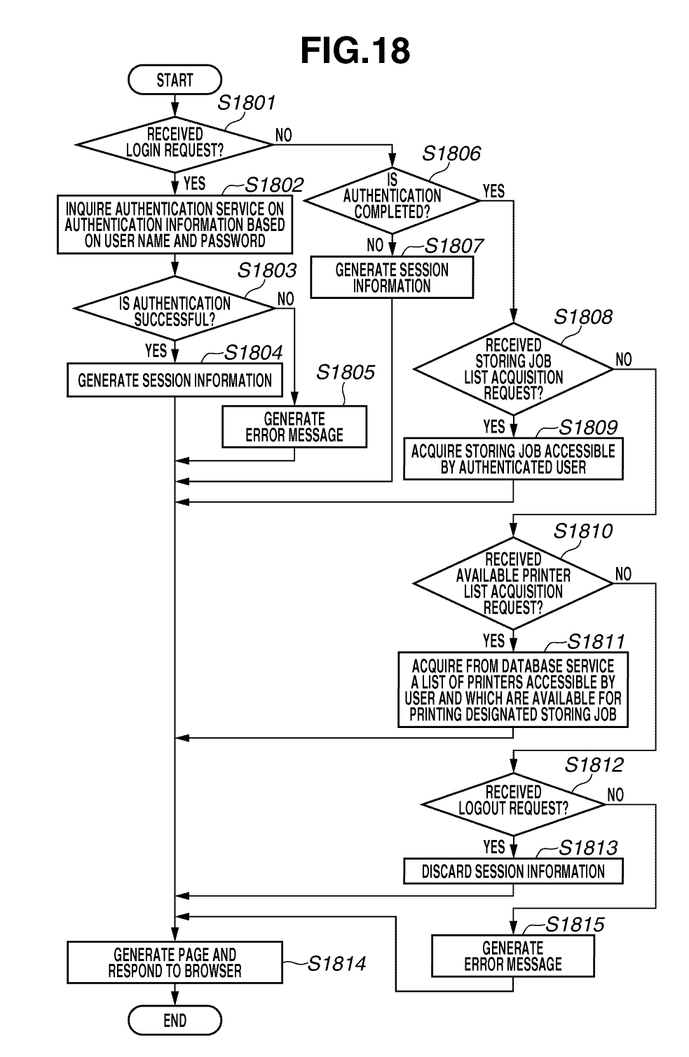

FIG. 18 illustrates a flowchart illustrating an operation flow of the web server 402 in one of the information processing apparatuses 101, 102, 103, and 104.

In step S1801, the web server 402 determines whether the login request is received from the web browser 406 in the information processing apparatus 105. If the web server 402 determines that the login request is received from the web browser 406 (YES in step S1801), the process proceeds to step S1802. On the other hand, if the web server 402 determines that the login request is not received from the web browser 406 (NO in step S1801), the process proceeds to step S1806.

In step S1802, the web server 402 transmits to the authentication service 407 the login request along with the user name and the password received from the web browser 406. Authentication is then performed. In step S1803, the web browser 402 determines whether the user can be authenticated as a result of authentication.

If authentication is successful (YES ins step S1803), the process proceeds to step S1804. In step S1804, the web server 402 creates and manages the session information in the session management unit 603. On the other hand, if authentication is not successful (NO in step S1803), the process proceeds to step S1805. In step S1805, the web server 402 generates an error message informing that authentication was not successful. The session information is the authentication information (i.e., user name and password).

In step S1806, the web server 402 determines whether authentication is completed. If authentication is not completed (NO in step S1806), the process proceeds to step S1807. In step S1807, the web server 402 generates an error message. If authentication is completed (YES in step S1806), the process proceeds to step S1808.

In step S1808, the web server 402 determines whether the storing job list acquisition request is received from the web browser 406. If the storing job list acquisition request is received (YES in step S1808), the process proceeds to step S1809. In step S1809, the web server 402 inquires on and acquires from the database service 405 the storing jobs, which are accessible by the login user (i.e., authenticated user).

In such a case, the web server 402 may acquire the storing jobs by designating a condition, for example, a number of acquired storing jobs, the document name, the user name, or the received date and time. Upon acquiring the information, which the database service 405 has extracted from the storing job information table 1001, the web server 402 creates the storing job list page 1704 based on the acquired information and the extracted information. The web server 402 then returns the storing job list page 1704 to the web browser 406 in response to the request.

On the other hand, if the storing job list acquisition request is not received (NO in step S1808), the process proceeds to step S1810.

In step S1810, the web server 402 determines whether the available printer list acquisition request is received from the web server 406. If the available printer list acquisition request is received (YES in step S1810), the process proceeds to step S1811. In step S1811, the web server 402 inquires the database service 405 on information about printers that are accessible by the login user and can print the designated storing job. The database service 405 then acquires the available printer list from the printer information table 1201 and transmits the list to the web server 402.

In step S1814, the web server 402 creates the printer list page 1709 and returns the page to the web browser 406 in response to the request. If the available printer list acquisition request is not received (NO in step S1810), the process proceeds to step S1812.

In step S1812, the web server 402 determines whether the logout request is received from the web browser 406. If the logout request is received (YES in step S1812), the process proceeds to step S1813. In step S1813, the web server 402 discards the session information. On the other hand, if the logout request is not received (NO in step S1812), the process proceeds to step S1815. In step S1815, the web server 402 generates an error message.

In step S1814, the web server 402 creates the appropriate page in response to the request according to the process result and returns the response page to the web browser 406.

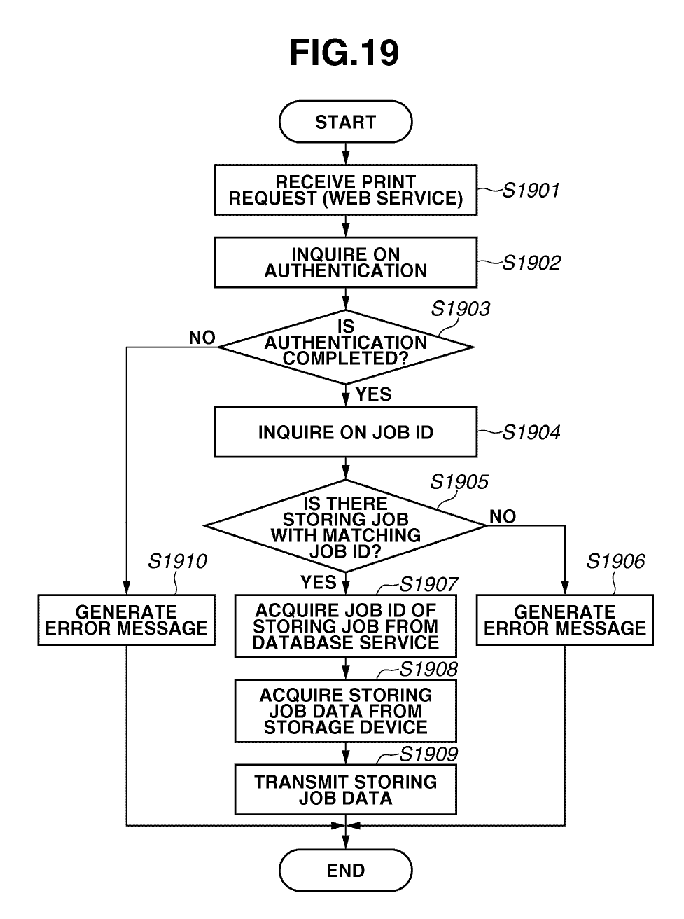

FIG. 19 illustrates a flowchart illustrating a process performed when the storing job management service 401 receives the print request from the pull-printing application 403.

In step S1901, the receiving unit 501 of the storing job management service 401 receives the print request from the pull-printing application 403. In step S1902, the storing job management service 401 inquires the authentication service 407 on authentication. More specifically, the information processing apparatuses 101, 102, 103, and 104 include a receiving unit. The receiving unit receives the print instruction from the image forming apparatus (image forming apparatus 105) designated from among the image forming apparatuses 107, 108, and 109, which are included in the available printer list. According to the present exemplary embodiment, the receiving unit 501 is an example of such a receiving unit.

In step S1903, the storing job management service 401 determines whether the user is already authenticated. If authentication has failed (NO in step S1903), the process proceeds to step S1910. In step S1910, the storing job management service 401 returns an error message to the pull-printing application 403, and the process ends. On the other hand, if authentication has been successful (YES in step S1903), the process proceeds to step S1904.

In step S1904, the storing job management service 401 inquires the database service 405 whether a job ID, which matches the job ID received with the print request from the pull-printing application 403, exists among the job ID 1003 in the storing job information table 1001.

If there is no matching job ID in the job ID 1003 (NO in step S1905), the process proceeds to step S1906. In step S1906, the storing job management service 401 transmits an error message to the pull-printing application 403, and the process ends. On the other hand, if there is a matching job ID (YES in step S1905), the process proceeds to step S1907. In step S1907, the storing job management service 401 acquires the matching job ID 1003 of the storing job from the database service 405.

In step S1908, the storing job management service 401 acquires the storing job data 1103, which matches the job ID 1102 from the storing job data stored in the storage device 106. In step S1909, the storing job management service 401 transmits the acquired storing job data 1103 to the pull-printing application 403.

Further, if the storing job management service 401 receives the substitute print request, the storing job management service 401 similarly acquires and transmits to the pull-printing application 403 the storing job data 1103. In other words, the information processing apparatuses 101, 102, 103, and 104 include a print data transmission unit. The print data transmission unit transmits, when a print instruction is received, the print data corresponding to the print instruction to the image forming apparatus designated by the information processing unit 105. According to the present exemplary embodiment, the storing job management service 401 is an example of such a print data transmission unit.

Further, if a substitute print instruction is received, the print data transmission unit transmits the print data corresponding to the substitute print instruction to the image forming apparatus designated by the information processing unit 105.

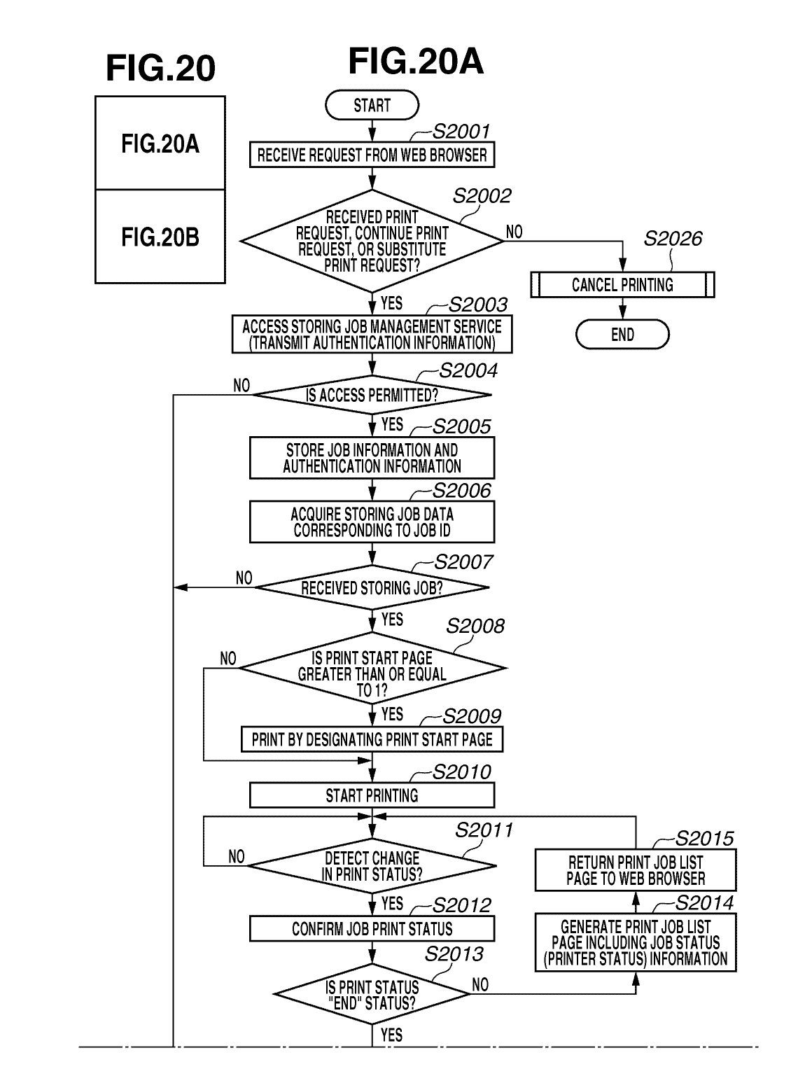

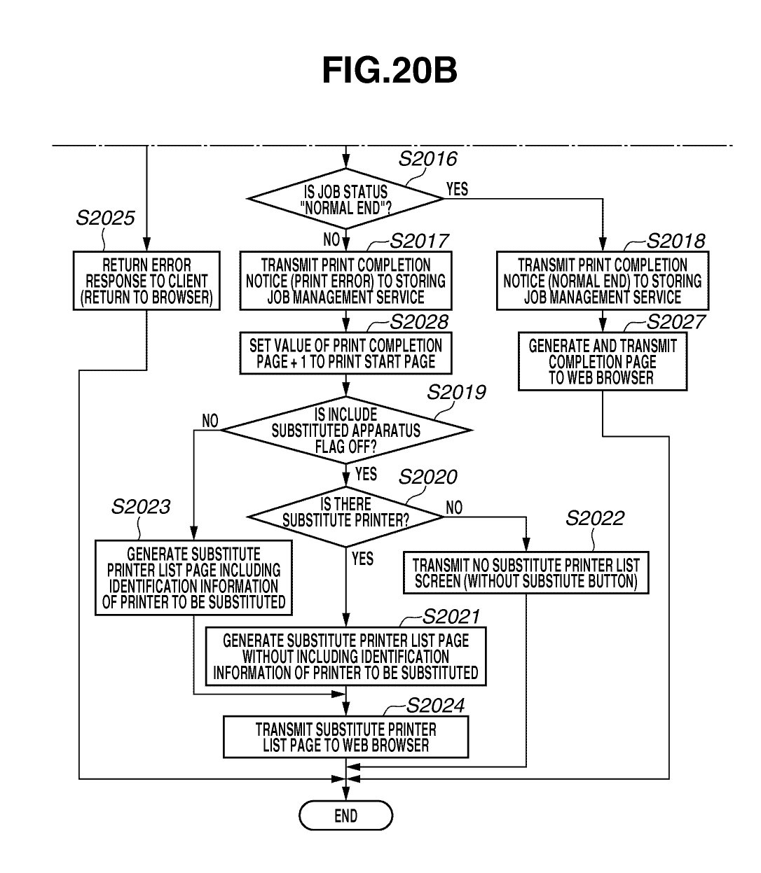

FIG. 20 illustrates a flowchart of a process performed when the pull-print application 403 receives the print request, the continue print request, and the substitute print request from the web browser 406.

In step S2001, the pull-print application 403 receives the request from the web browser 406. In step S2002, the pull-print application 403 determines whether the received request is the print request, the continue print request, or the substitute print request.

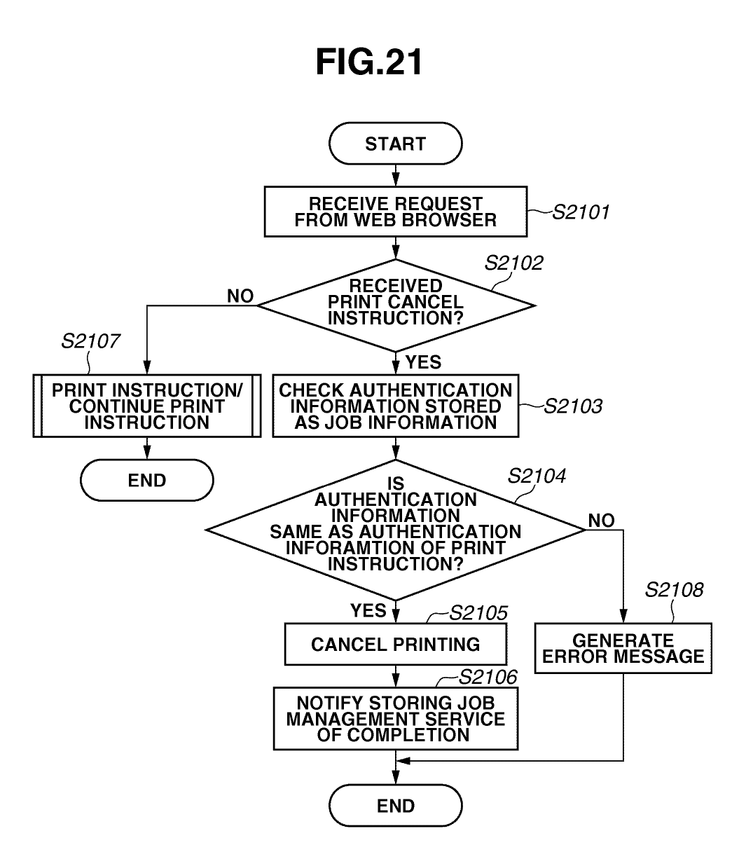

If the received request is neither the print request, the continue print request, nor the substitute print request (NO in step S2002), the process proceeds to step S2026. In step S2026, if printing is to be cancelled, the pull-print application 403 performs the print cancel process as illustrated in FIG. 21 to be described below. If the received request is one of the print request, the continue print request, and the substitute print request (YES in step S2002), the value of the request type in the instruction information 1403 indicates “print”.

In other words, the image forming apparatuses 107, 108, and 109 include a print instruction receiving unit (e.g., the pull-printing application 403, or more specifically the request receiving unit 801). The print instruction receiving unit receives the print instruction from the information processing apparatus 105. According to the present exemplary embodiment, an example of the print instruction is the print request.

Further, the image forming apparatuses 107, 108, and 109 include a substitute print instruction receiving unit (e.g., the pull-printing application 403, or more specifically the request receiving unit 801). The substitute print instruction receiving unit receives the substitute print instruction from the information processing apparatus 105. According to the present exemplary embodiment, the substitute print request is an example of the substitute print instruction.

In step S2003, the pull-printing application 403 accesses the storing job management service 401. More specifically, the pull-printing application 403 transmits to the storing job management service 401 the authentication information 1409 in the instruction information 1403 included in the printer list information illustrated in FIG. 14. Otherwise, the pull-printing application 403 transmits to the storing job management service 401 the authentication information 1612 in the instruction information 1606 included in the substitute printer list page information illustrated in FIG. 16. The storing job management service 401 then performs authentication by inquiring the authentication service 407.

In step S2004, the pull-printing application 403 determines whether access is permitted. If access is not permitted (NO in step S2004), the process proceeds to step S2025. In step S2025, the pull-printing application 403 returns an error page to the web browser 406 as a response.

On the other hand, if access is permitted (YES in step S2004), the process proceeds to step S2005. In step S2005, the pull-printing application 403 stores in the authentication information 1306 the information in the instruction information 1403 or in the instruction information 1606 together with the information received from the authentication service 407.

In step S2006, the pull-printing application 403 acquires from the storing job management service 401 the storing job data 1103 corresponding to the job ID 1406 in the instruction information 1403 or the job ID 1609 in the instruction information 1606.

More specifically, the image forming apparatuses 107, 108, and 109 include a print data acquisition unit that acquires the print data from the information processing apparatuses 101, 102, 103, and 104. The print data is acquired based on the information about the print data included in the print instruction or the substitute print instruction (i.e., job ID 1406 and job ID 1609). According to the present exemplary embodiment, the pull-printing application 403 is an example of the print data acquisition unit.

In step S2007, the pull-printing application 403 determines whether the storing job data 1103 is successfully received. If the storing job data 1103 is not received (NO in step S2007), the process proceeds to step S2025 in which the pull-printing application 403 returns an error page to the web browser 406 as a response.

If the storing job data 1103 is received (YES in step S2007), the process proceeds to step S2008. In step S2008, the pull-printing application 403 determines whether the print start page 1407 in the instruction information 1403 or the print start page 1610 in the instruction information 1606 is greater than or equal to 1.

If the print start page 1407 or the print start page 1610 is greater than or equal to 1 (YES in step S2008), the process proceeds to step S2009. In step S2009, the pull-printing application 403 designates the print start page and performs printing.

In step S2010, upon receiving the print request, the print control unit 804 transmits the storing job data 1103 acquired by the storing job data acquisition unit 802 to the print processing unit 711 via the interface of the virtual machine 704. Printing is thus performed.

In other words, the image forming apparatuses 107, 108, and 109 include a printing unit for printing the print data acquired by the pull-printing application 403. According to the present exemplary embodiment, the virtual machine 704, the print processing unit 711, the storing job data acquisition unit 802, and the print control unit 804 are examples of the printing unit. If the print unit receives the substitute print instruction, the print unit prints the print data from the print start page included in the substitute print instruction.

In step S2011, the pull-printing application 403 determines whether a change in the print status is detected. If a change in the print status is detected (YES in step S2011), the process proceeds to step S2012. In step S2012, the pull-printing application 403 inquires and confirms the print processing unit 711 on the print status of the job.

In step S2013, the pull-printing application 403 determines whether the job status is an end status. If the job status is not an end status (NO in step S2013), such as “waiting” or “printing”, the process proceeds to step S2014. In step S2014, the pull-printing application 403 creates the print job list page 1711.

The print job list page 1711 at least includes the status 1506 and the printer status 1503 in the print job list page 1711. In step S2015, the pull-printing application 403 returns the print job list page 1711 to the web browser 406.

The image forming apparatuses 107, 108, and 109 thus include a print status information transmission unit (e.g., the pull-printing application 403) that creates and transmits to the information processing apparatus 105 the information about the print execution status. According to the present exemplary embodiment, the status 1506 and the printer status 1503 are examples of the information about the print execution status.

More specifically, the pull-printing application 403 creates a print status information page including information indicating the print execution status (e.g., the print job list page 1711). The pull-printing application 403 then transmits the print status information page to the web browser 406 in the information processing apparatus 105. As a result, information indicating the print execution status is transmitted when the print status changes, so that the user can appropriately perform the printing process and the substitute printing process.

In step S2016, the pull-printing application 403 determines whether the job has normally ended. If the job has normally ended (YES in step S2016), the process proceeds to step S2018. In step S2018, the pull-printing application 403 transmits to the storing job management service 401 a notice that the printing has normally ended (i.e., a print completion notice).

In step S2027, the pull-printing application 403 creates a page indicating completion and transmits the page to the web browser 406. The process of step S2016 is performed when the job status is an end status such as “normal end” or “printing error”.

On the other hand, if the job has not ended normally (NO in step S2016), the process proceeds to step S2017. In step S2017, the pull-printing application 403 transmits to the storing job management service 401 a notice that printing has ended due to an error (i.e., a print completion notice). Printing is not normally ended when the job status is “printing error”.

In step S2028, the pull-printing application 403 sets a value of “print end page+1” to the print start page 1610. The pull-printing application 403 then transmits the set information to the information processing apparatus 105 in step S2024, which will be described below. In other words, the pull-printing application 403 sets a page subsequent to the page that has been printed as the print start page. The pull-printing application 403 then transmits the print start page to the information processing apparatus 105 by including in the substitute printer list information.

In step S2019, the pull-printing application 403 determines whether the “include substituted printer” flag 1410 is off.

If the “include substituted printer” flag 1410 is off (YES in step S2019), the process proceeds to step S2020. In step S2020, the pull-printing application 403 determines whether there is a substitute printer, i.e., the substitute printer identification information 1411. If there is the substitute printer identification information 1411 (YES in step S2020), the process proceeds to step S2021. In step S2021, the pull-printing application 403 creates the substitute printer list page 1713 including the substitute printer list. The substitute printer list page 1713 includes as the substitute printer list the substitute printer identification information from which identification information of the printer to be substituted is excluded. The process then proceeds to step S2024.

On the other hand, if there is no substitute printer identification information 1411 (NO in step S2020), the process proceeds to step S2022. In step S2022, the pull-printing application 403 creates the substitute printer list page 1713 without the substitute printer identification information.

The pull-printing application 403 then transmits the substitute printer list page 1713 to the web browser 406. In such a case, the substitute print button 1717 is not displayed in the substitute printer list page 1713.

More specifically, if the pull-printing application 403 determines that there is no image forming apparatuses 107, 108, and 109 to be a candidate for performing substitute printing, the pull-printing application 403 creates the substitute printer list information. The pull-printing application 403 then transmits the substitute printer list information to the information processing apparatus 105.

The substitute printer list information thus created by the pull-printing application 403 includes information indicating that there is no image forming apparatuses 107, 108, and 109 to be a candidate for performing substituting printing (i.e., information indicating not to display the substitute print button 1717). Further, the pull-printing application 403 creates the substitute printer list information based on the identification information for identifying the image forming apparatuses 107, 108, and 109 included in the print instruction (i.e., the instruction information 1403).

If the “include substituted printer” flag 1410 is on (NO in step S2019), the process proceeds to step S2023. In step S2023, the pull-printing application 403 creates the substitute printer list page 1713 including the substitute printer list. The substitute printer list includes the identification information of the printer to be substituted in the substitute printer identification information.

More specifically, the pull-printing application 403 determines whether to include the image forming apparatus that is to be substituted as the image forming apparatus as a candidate for performing substitute printing, based on the setting information included in the print instruction. The pull-printing application 403 then creates and transmits to the information processing apparatus 105 the substitute printer list information. According to the present exemplary embodiment, the “include substituted printer” flag 1410 is an example of the setting information included in the print instruction.

In step S2024, the pull-printing application 403 transmits to the web browser 406 the substitute printer list information 1601 or the substitute printer list page 1713.

In other words, the image forming apparatuses 107, 108, and 109 include a substitute printing apparatus list information transmission unit that transmits, when an error has occurred while printing, the substitute printer list information to the information processing apparatus 105 (an example of the substitute printing apparatus list information transmission unit is the pull-printing application 403). More specifically, the pull-printing application 403 creates a substitute printer list page including the substitute printer list information (e.g., the substitute printer list page information 1601). The pull-printing application 403 then transmits the substitute printer list page to the web browser 406 in the information processing apparatus 105.

The substitute printer list information is information indicating the image forming apparatuses 107, 108, and 109 that are candidates for performing substituting printing. Further, the substitute printer list information is created by the pull-printing application 403 based on the identification information for identifying the image forming apparatuses 107, 108, and 109 included in the print instruction.

Further, the substitute printer list page information 1601 and the substitute printer list page 1713 include the print start page 1610 (refer to FIG. 16). The pull-printing application 403 thus transmits to the information processing apparatus 105 the print information including the information on the remaining print content in a case where printing is not completed.

According to the present exemplary embodiment, the print start page 1610 is an example of the information on the remaining print content in a case where printing is not completed. In such a case, the pull-print application 403 transmits to the information processing apparatus 105 the print information in addition to the information on whether printing is normally ended (e.g., a print completion notice).

According to the above-described process, when printing is not completed, the information on the remaining print content is included in the print information. As a result, the image forming apparatuses 107, 108, and 109, which are instructed to perform substitute printing, can recognize the content that has been printed. The image forming apparatuses 107, 108, and 109 can thus print only the remaining content.

As described above, the user can issue the print instruction from the web browser 406 to the image forming apparatuses 107, 108, and 109 by the web browser 406 that displays the substitute printer list page including the various information on the substitute printers. As a result, since the print instruction is issued from the information processing apparatus 105 to the image forming apparatuses 107, 108, and 109, determination on whether to perform substitute printing can be determined without involving the information processing apparatuses 101, 102, 103, and 104.

FIG. 21 illustrates a flowchart illustrating a process performed when the pull-printing application 403 receives the print cancel request.

In step S2101, the pull-printing application 403 receives a request from the web browser 406. In step S2102, the pull-printing application 403 determines whether the received request instructs print canceling.

If the received request is the print request, the continue print request, or the substitute print request (NO in step S2102), the process proceeds to step S2107. In step S2107, the pull-printing application 403 performs a series of processes according to the print request, the continue print request, or the substitute print request.

On the other hand, if the received request is a print cancel request (YES in step S2102), the process proceeds to step S2103. In step S2103, the pull-printing application 403 checks whether the authentication information received with the request matches the authentication information in the print instruction. The pull-printing application 403 checks on the above based on the authentication information 1306 in the print job information 1301 and the authentication information 1409 in the instruction information 1403. In other words, the pull-printing application 403 checks whether the received authentication information is the same as the authentication information in the print instruction. In the above-described case, the request type of the instruction information is a value indicating “print cancel”.

In step S2104, the pull-printing application 403 determines whether the authentication information is the same as the authentication information in the print instruction. If the authentication information is the same as the authentication information in the print instruction (YES in step S2104), the process proceeds to step S2105. In step S2105, the pull-printing application 403 issues the print cancel instruction to the print processing unit 711 via the virtual machine 704. In step S2106, the pull-printing application 403 then notifies the storing job management service 401 of completion of the process.

If the authentication information is not the same as the authentication information in the print instruction (NO in step S2104), the process proceeds to step S2108. In step S2108, the pull-printing application 403 creates and transmits to the web browser 406 an error page in response to the request.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-034519 filed Feb. 17, 2009, which is hereby incorporated by reference herein in its entirety.

What is claimed is:

1. An apparatus comprising:
a receiving unit configured to receive an instruction from a client terminal;
an acquisition unit configured to acquire print data from a server based on information about print data included in the received instruction;
a print unit configured to perform printing of the acquired print data; and
a first transmission unit configured to create, if an error has occurred when the print unit performs printing, substitute printing information indicating an image forming apparatus to be a candidate for substituting printing, based on identification information for identifying the apparatus, which is included in the received instruction, and to transmit the substitute printing information to the client terminal.

2. The apparatus according to claim 1, wherein the receiving unit receives the print instruction from a web browser in the client terminal, and
wherein the first transmission unit creates and transmits a substitute page including the substitute information to the web browser.

3. The apparatus according to claim 1, further comprising a second transmission unit configured to create and transmit to a web browser in the client terminal a print status information page including information indicating a print execution status of the print unit.

4. The apparatus according to claim 1, wherein the first transmission unit sets a page subsequent to a page that is printed by the print unit as a print start page and transmits the print start page included in the substitute information to the client terminal.

5. The apparatus according to claim 1, wherein the first transmission unit determines whether to include the apparatus to be substituted as the image forming apparatus to be a candidate for performing substitute printing according to setting information included in the received print instruction and creates the substitute information including or not including the apparatus to be substituted as a substitute printer based on the determination.

6. The apparatus according to claim 1, wherein the first transmission unit creates, when it is determined that there is no image forming apparatus to be a candidate for performing substitute printing based on identification information for identifying the apparatus included in the received print instruction, substitute information indicating that there is no image forming apparatus to be a candidate for performing substitute printing.

7. An apparatus comprising:
a receiving unit configured to receive from a client terminal an instruction for performing substitute printing;
an acquisition unit configured to acquire print data from a server based on information about print data included in the received instruction; and
a print unit configured to perform printing of the acquired print data from a print start page included in the received instruction.

8. The apparatus according to claim 7, wherein the receiving unit receives from a web browser in the client terminal the instruction for performing substitute printing.

9. A method of an apparatus comprising:
receiving an instruction from a client terminal;
acquiring print data from a server based on information about print data included in the received instruction;
printing the acquired print data; and
creating, if an error has occurred when printing the acquired print data, substitute printing information indicating an image forming apparatus to be a candidate for substituting printing, based on identification information for identifying the apparatus included in the received instruction, and transmitting the substitute printing information to the client terminal.

10. A method of an apparatus comprising:
receiving from a client terminal an instruction for performing substitute printing;
acquiring print data from a server based on information about print data included in the received instruction; and
printing the acquired print data from a print start page included in the received instruction.

11. A computer-readable storage medium storing a program for causing a computer to execute a method of an apparatus, the method comprising:
receiving an instruction from a client terminal;
acquiring print data from a server based on information about print data included in the received instruction;
printing the acquired print data by a print unit; and
creating, if an error has occurred when printing the acquired print data, substitute printing information indicating an image forming apparatus to be a candidate for substituting printing, based on identification information for identifying the apparatus which is included in the received instruction and transmitting the substitute printing information to the client terminal.

12. A computer-readable storage medium storing a program for causing a computer to execute a method of an apparatus, the method comprising:
receiving from a client terminal an instruction for performing substitute printing;
acquiring print data from a server based on information about print data included in the received instruction; and
printing the acquired print data from a print start page included in the received substitute print instruction.

13. The method according to claim 9, further comprising creating and transmitting to a web browser in the client terminal a print status information page including information indicating a print execution status of a print unit.

14. The method according to claim 9, further comprising setting a page subsequent to a page that is printed by a print unit as a print start page and transmitting the print start page included in the substitute information to the client terminal.

15. The method according to claim 9, further comprising determining whether to include the apparatus to be substituted as the image forming apparatus to be a candidate for performing substitute printing according to setting information included in the received print instruction and creating the substitute information including or not including the apparatus to be substituted as a substitute printer based on the determination.

16. The method according to claim 9, further comprising creating, when it is determined that there is no image forming apparatus to be a candidate for performing substitute printing based on identification information for identifying the apparatus included in the received print instruction, substitute information indicating that there is no image forming apparatus to be a candidate for performing substitute printing.

17. The computer-readable storage medium according to claim 11, further comprising creating and transmitting to a web browser in the client terminal a print status information page including information indicating a print execution status of the print unit.

18. The computer-readable storage medium according to claim 11, further comprising setting a page subsequent to a page that is printed by the print unit as a print start page and transmitting the print start page included in the substitute information to the client terminal.

19. The computer-readable storage medium according to claim 11, further comprising determining whether to include the apparatus to be substituted as an image forming apparatus to be a candidate for performing substitute printing according to setting information included in the received print instruction and creating the substitute information including or not including the apparatus to be substituted as a substitute printer based on the determination.

20. The computer-readable storage medium according to claim 11, further comprising creating, when it is determined that there is no image forming apparatus to be a candidate for performing substitute printing based on identification information for identifying the apparatus included in the received print instruction, substitute information indicating that there is no image forming apparatus to be a candidate for performing substitute printing.
